(19) United States
(12) Patent Application Publication
(10) Pub. No.: US 2022/0204158 A1
(43) Pub. Date: Jun. 30, 2022

(54) CARRIER AIRCRAFT

(71) Applicant: Bellwether Industries Limited, London (GB)

(72) Inventors: Kun-Yang CHEN, Hsinchu City (TW); Kai-Tse LIN, Tainan City (TW); Chenchang LI, London (GB); Zhiyang YU, London (GB); Yin-Hua HSU, Magong City (TW)

(21) Appl. No.: 17/331,292

(22) Filed: May 26, 2021

(30) Foreign Application Priority Data
Dec. 30, 2020 (TW) 109146821

(51) Int. Cl. B64C 29/00; B64C 15/02

(52) U.S. Cl. CPC B64C 29/0033; B64C 15/02

(57) ABSTRACT

A carrier aircraft, comprising: a body for carrying at least one object or passenger; and multiple rotatable fan devices disposed on two sides of said body; wherein an angle of rotation of one of said rotatable fan devices can be changed, such that said carrier aircraft flies along a direction at an angle, said angle being between 0 degrees to 30 degrees.

### FIELD OF INVENTION

The present invention relates to a carrier aircraft, where the aircraft can perform lateral leveled flight.

### BACKGROUND OF INVENTION

Existing carrier aircrafts must tilt the aircraft during forward flight, mainly because power propulsion devices such as fans can only exhaust to a fixed direction. However, such forward flight in a tilted state will cause discomfort to the passengers in the aircraft, and forward flight in tilted state is also more doubtful in the safety aspect. Furthermore, such existing carrier aircrafts have a low degree of freedom in flight dynamics, only having three degrees of freedom: i.e. pitch, roll and yaw etc., therefore they are hard to be utilized in narrow areas such as urban areas, greatly limiting the area of use.

### SUMMARY OF INVENTION

An aircraft, comprising: a main body for carrying at least one object or passenger; and multiple rotatable fan devices, disposed at two sides of main body; wherein an angle of rotation of one of the multiple rotatable fan devices can be changed, such that the aircraft flies along a direction at an angle between 0 degrees and 30 degrees.

The aircraft wherein the multiple rotatable fan devices comprises at least four groups symmetrically disposed at two sides of main body.

The aircraft wherein an angle of rotation of multiple rotatable fan devices can be changed, such that the aircraft can perform lateral flight.

The aircraft further comprising: two front wings symmetrically disposed at two sides of a front part of the main body, wherein a front fan group of the multiple rotatable fan devices is disposed on two front wings respectively; two rear wings symmetrically disposed at two sides of a rear part of the main body, wherein a rear fan group of the multiple rotatable fan devices is disposed on two rear wings respectively; and a tail wing disposed at a tail part of main body.

The aircraft wherein the front fan group comprises four rotatable fan groups with two disposed on each of two front wings, and the rear fan group comprises four rotatable fan groups with two disposed on each of two rear wings.

The aircraft wherein a first average distance between the front fan group and the main body is smaller than a second average distance between the rear fan group and the main body.

The aircraft wherein a third average distance between the front fan group and a bottom surface of the main body is smaller than a fourth average distance between the rear fan group and the bottom surface of main body.

The aircraft wherein the tail wing comprises two tail fins disposed at two sides of the tail part of main body respectively.

The aircraft wherein one of the multiple rotatable fan devices comprises a rotatable ducted fan.

The aircraft wherein one of the multiple rotatable fan devices further comprises a frame, wherein the rotatable ducted fan is disposed at a central region of said frame.

The aircraft wherein the rotatable ducted fan further comprises: a ducted fan, a first angle adjustment device for controlling the ducted fan to change an angle along a first plane; a second angle adjustment device for controlling the ducted fan to change an angle along a second plane; wherein the first plane is orthogonal to said second plane.

The aircraft wherein the rotatable ducted fan further comprises: a ducted fan fixed housing for accommodating and fixing ducted fan; and a ducted fan movable housing for accommodating ducted fan; wherein the first angle adjustment device and the second angle adjustment devices are coupled to the ducted fan fixed housing and the ducted fan movable housing.

The aircraft wherein at least one of first angle adjustment device and second angle adjustment device is a lever structure for adjusting an angle of rotation of ducted fan movable housing.

A method of driving an aircraft, said aircraft comprising a main body for carrying at least one object or passenger, and multiple rotatable fan devices disposed on the main body, said method comprising: driving a first part of the multiple rotatable fan devices, causing the first part to exhaust to a ground direction; driving a second part of the multiple rotatable fan devices, causing the second part to exhaust to a first direction; and driving carrier aircraft to perform lateral flight towards a second direction.

The method wherein an angle between first direction and second direction is greater than 150 degrees.

The method further comprising: controlling two rotatable fans of second part disposed at corresponding positions on two sides of the main body to rotate in a clockwise direction and an anti-clockwise direction respectively, causing said aircraft to stop suddenly from a flying state.

### BRIEF DESCRIPTION OF DRAWINGS

FIG. 1 is a top isometric view of the aircraft 100 of the present invention.

FIG. 2 is a bottom isometric view of the aircraft 100 of the present invention.

FIG. 3 is a plan view of the aircraft 100 of the present invention.

FIG. 4A is a left side view of the aircraft 100 of the present invention.

FIG. 4B is a right side view of the aircraft 100 of the present invention.

FIG. 5 is a front view of the aircraft 100 of the present invention.

FIG. 6 is a magnified side view of rotatable fan device 1104, 1106 of the present invention.

FIG. 7 is a magnified front view of rotatable fan device 1104, 1106 of the present invention.

FIGS. 8A, 8B, 8C illustrates control of rotatable fan device 1104, 1106, causing exit air flow to flow along direction 804 and direction 806.

FIGS. 9A and 9B is a magnified view of a rotatable ducted fan of the aircraft 100.

FIG. 10 is a plan view of another aircraft 200 of the present invention.

### DETAILED DESCRIPTION OF INVENTION

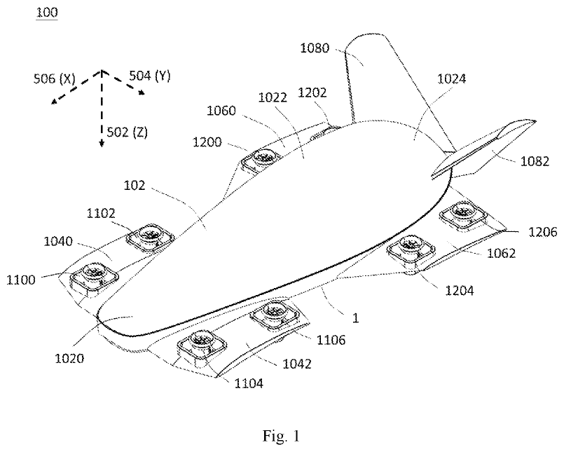

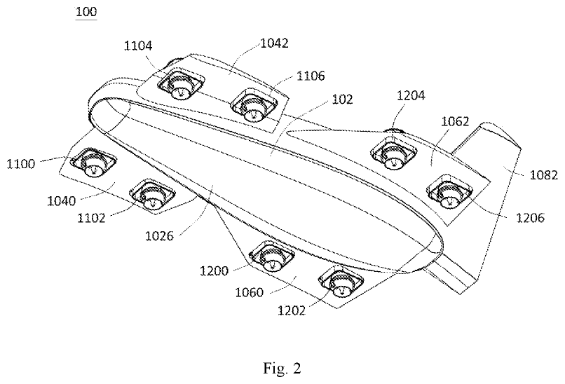

Referring to FIG. 1 and FIG. 2, being a top isometric view and a bottom isometric view of an aircraft according to an embodiment of the present invention, where three directions X (506), Y (504), Z (502) of the aircraft is shown. In this embodiment, the aircraft 100 comprises: a main body 102, a pair of front wings 1040 and 1042 disposed at two sides of a front part 1020 of the main body 102, and a pair of rear wings 1060 and 1062 disposed at two sides of a rear part 1022 of the main body 102. A pair of tail wings 1080 and 1082 are disposed at two sides of a tail part 1024 of the main body 102. In another embodiment, the main body 102, the front wings 1040 and 1042, the rear wings 1060 and 1062 can be made in one piece, this will further reduce drag and increase the toughness of the aircraft.

The main body 102 can carry at least one object or passenger, a top part of the main body 102 can be designed as an elliptical streamline shape as an example for reducing air resistance during flight; a bottom part of the main body 102 comprises a bottom surface 1026, in an example the bottom surface 1026 can include flat surfaces as a part thereof, allowing the aircraft 100 to stably stand on the ground when idle.

In this embodiment, rotatable fan devices 1100, 1102 and 1104, 1106 are disposed on the front wings 1040 and 1042 respectively, these fans form a front fan group symmetrically disposed on two sides of the main body 102; rotatable fan devices 1200, 1202 and 1204, 1206 are disposed on the rear wings 1060 and 1062 respectively, these fans form a rear fan group, symmetrically disposed on two sides of the main body 102. Obviously it is able to replace some fan groups by non-rotatable (fixed) fan devices to control the overall cost and weight of the aircraft.

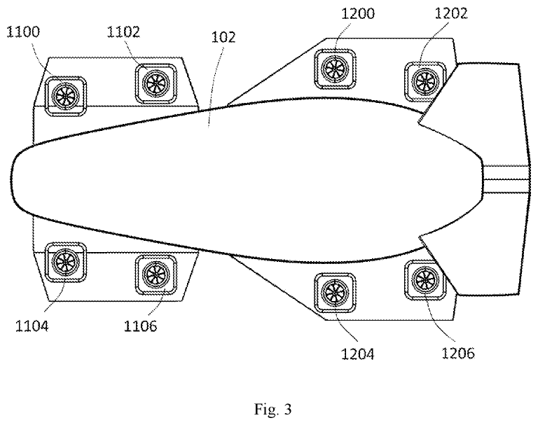

Referring to FIG. 3, being a plan view of the aircraft 100, a first average distance between the front fan group (rotatable fan devices 1100, 1102, 1104, 1106) and the main body 102 is smaller than a second average distance between the rear fan group (rotatable fan devices 1200, 1202, 1204, 1206) and the main body 102. The present feature is designed corresponding to the main body 102, achieving an improved stability and operational flexibility for the aircraft 100.

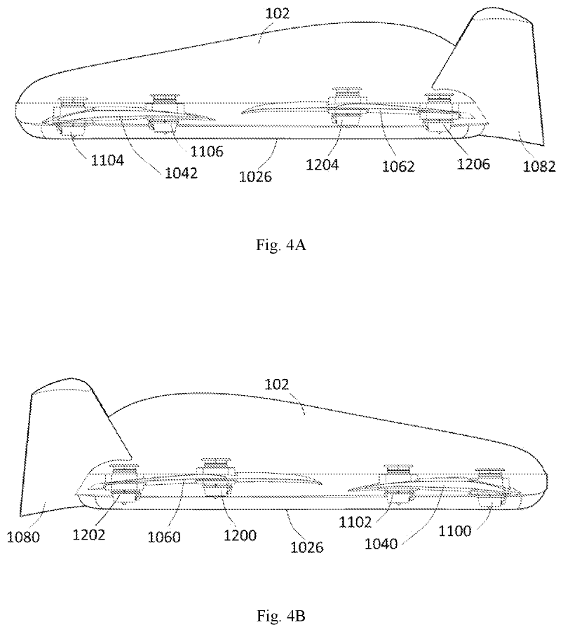

Referring to FIGS. 4A and 4B, being the left side view and the right side view of the aircraft 100, to further increase the overall stability and operational flexibility, the aircraft can be designed such that the front fan group (rotatable fan devices 1100, 1102, 1104, 1106) and the bottom surface 1026 of the main body 102 has a third average distance therebetween, and the rear fan group (rotatable fan devices 1200, 1202, 1204, 1206) and the bottom surface 1026 of the main body 102 has a fourth average distance therebetween, wherein the third average distance is smaller than the fourth average distance.

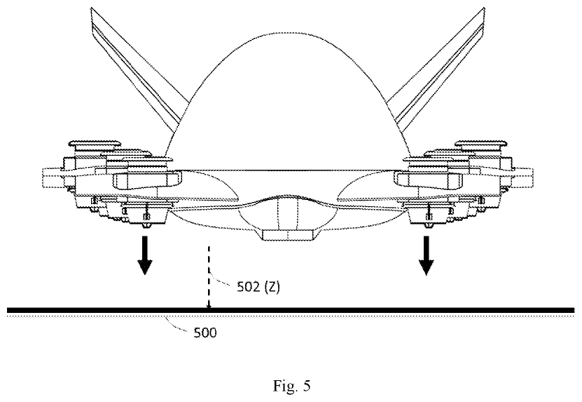

Referring to FIG. 5, being the front view of the aircraft 100, when the aircraft is in idle or hovering state, the exit air flow direction of rotatable fan devices 1100, 1102, 1104, 1106, 1200, 1202, 1204, 1206 is normal to ground plane 500 (parallel to ground plane normal direction 502). In another embodiment, some of the rotatable fan devices can be adjusted, for example rotatable fan devices 1202, 1206, making a slight tiling angle (0-10 degrees) against the direction normal to the ground plane 500, such that aircraft 100 has a less forward momentum while still able to maintain relatively stable hovering.

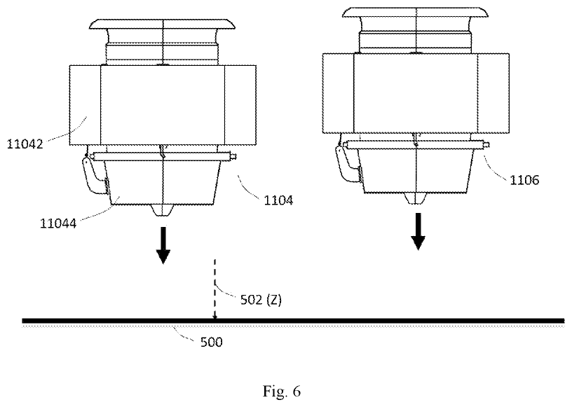

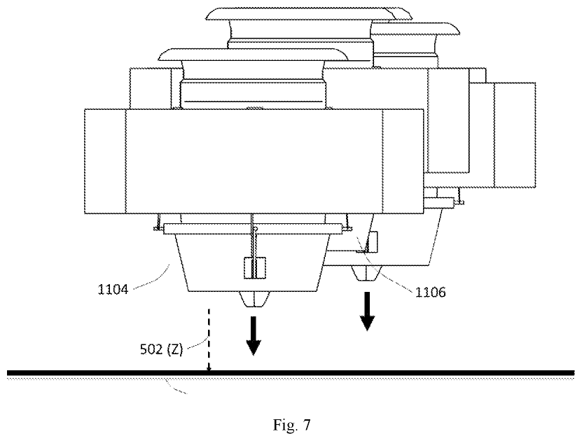

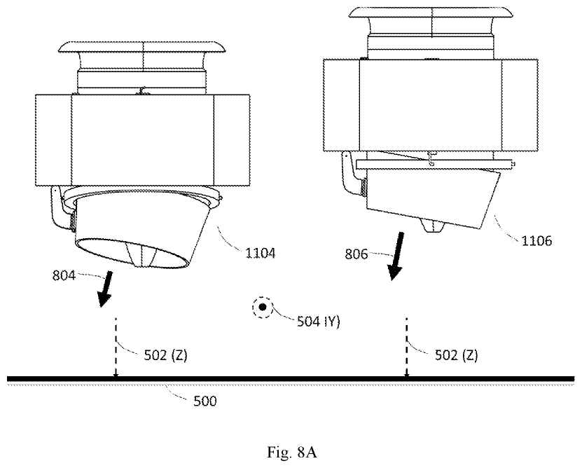

Referring to FIG. 6 and FIG. 7, being a magnified side view and a magnified front view of the rotatable fan device 1104, 1106 in FIG. 4A, wherein the rotatable fan device 1104 (rotatable fan device 1106 has a same structure) comprises: a fan frame 11042 for fixing the rotatable fan device 1104 to the front wing 1042, a rotatable ducted fan accommodated and fixed to a central region of the fan frame 11042. At this state the exit air flow direction of the rotatable fan devices 1104, 1106 are approximately normal to the ground plane 500 (parallel to ground plane normal direction 502, or Z direction).

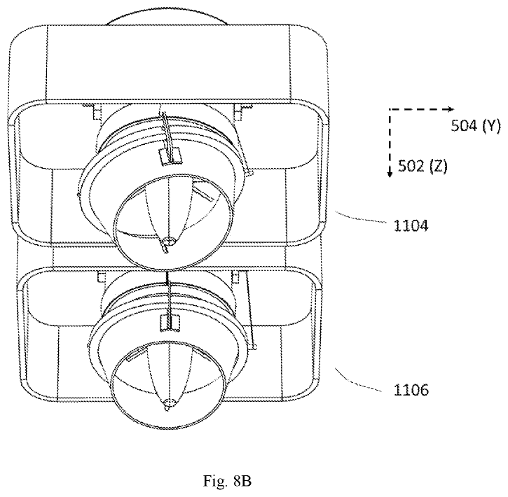

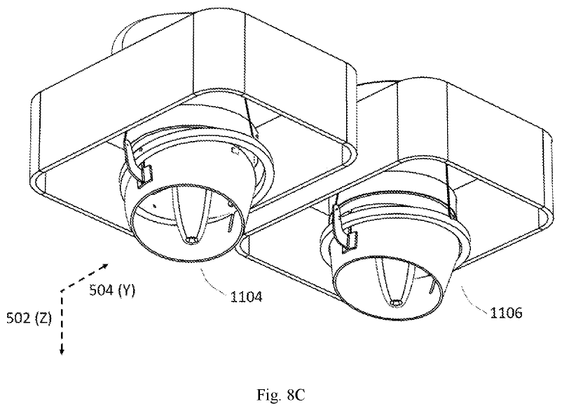

Referring to FIG. 8A, FIG. 8B and FIG. 8C, control of rotatable fan devices 1104, 1106 is illustrated, causing the exit air flow direction to be along direction 804 and direction 806 respectively. Two reference directions are shown in the figures, being normal direction 502 (Z direction) to ground plane 500 and direction pointing outwards 504 (i.e. Y direction, same as direction 504 of FIG. 8B and FIG. 8C). Direction 806 of rotatable fan device 1106 makes an angle to normal direction 502, but rotatable fan device 1106 does not have a tilting angle along direction 504. Direction 804 of rotatable fan device 1104 makes an angle to normal direction 502, and also has a tilting angle along direction 504. Such design and control of rotatable fan devices provides aircraft 100 with degrees of freedom of forward and backward movement and sideways movement, along with exit air volume of the fans allowing vertical movement for the aircraft 100, thereby providing six degrees of freedom to the aircraft of the present invention, comparing to traditional aircrafts having only 3 or 4 degrees of freedom, the degree of freedom is significantly increased.

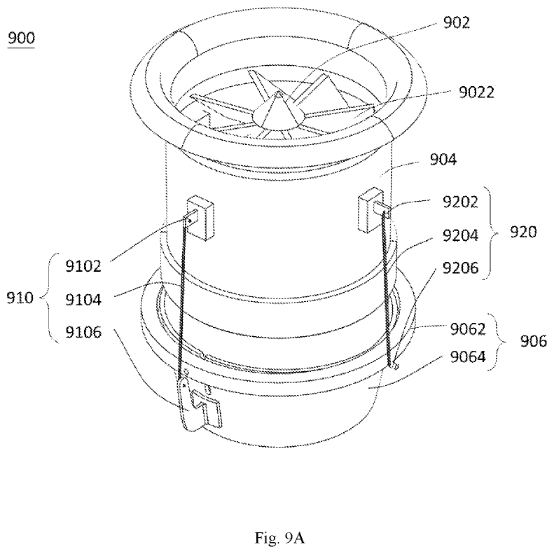

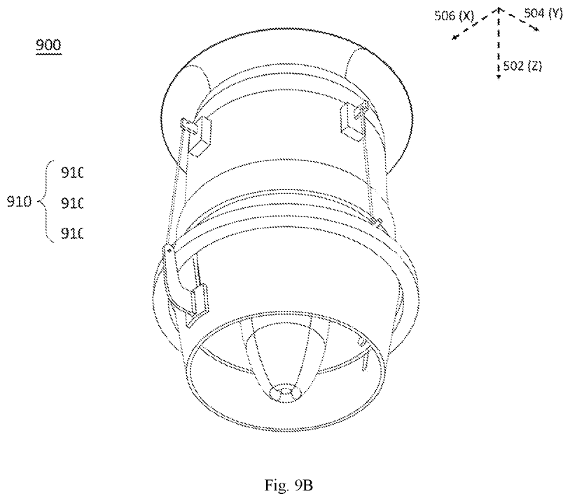

Referring to FIG. 9A and FIG. 9B, being magnified views of a rotatable ducted fan 900 of the aircraft 100, where FIG. 9B further illustrates three directions X (506), Y (504), Z (502) of the aircraft. The rotatable ducted fan 900 comprises: a ducted fan 902 for compressing air flow; a ducted fan fixed housing 904 for accommodating and fixing the ducted fan 902; a ducted fan movable housing 906, comprising a movable interior housing 9064 and a movable exterior housing 9062, for accommodating the ducted fan 902 and controlling an angle of air flow thereof; an angle adjustment lever 910, coupled to the ducted fan fixed housing 904 and the movable interior housing 9064, for controlling the ducted fan movable housing 906 to rotate along X direction; an angle adjustment lever 920, coupled to the ducted fan fixed housing 904 and the movable exterior housing 9062, for controlling the ducted fan movable housing 906 to rotate along Y direction.

The angle adjustment lever 910 comprises: a lever moving device 9102, a lever 9104 and a lever fixing device 9106. The lever moving device 9102 moving up and down will drive lever 9104 to move up and down and pull the moving interior housing 9064, such that the entire ducted fan movable housing 906 rotates along X direction. Similarly, angle adjustment lever 920 comprises: a lever moving device 9202, a lever 9204 and a lever fixing device 9206. The lever moving device 9202 moving up and down will drive lever 9204 to move up and down and pull the moving exterior housing 9062, such that the entire ducted fan movable housing 906 rotates along Y direction.

Referring to FIG. 1, a method for driving an aircraft 100 is explained. When the aircraft 100 starts to fly from an idle state on the ground, the method drives rotatable fan devices 1100, 1102, 1104, 1106, 1200, 1202, 1204, 1206, to start blowing air towards the Z direction normal to ground plane, thereby the aircraft 100 flies upwards. In another embodiment, where the loaded object or passengers have a lower weight or due to power saving considerations, some of the rotatable fan devices are not powered, for example only driving rotatable fan devices 1100, 1104, 1202, 1206.

After the aircraft 100 is airborne, movement can be started. Assuming the aircraft wants to fly towards X direction (direction 506), some of the rotatable fan devices, such as 1102, 1106, 1200, 1204 can be controlled to rotate towards a direction opposite (or having an angle greater than 150 degrees) to the X direction (direction 506), thereby driving aircraft 100 to fly towards X direction (direction 506) laterally and stably; if the aircraft wants to fly towards a direction opposite to X direction (direction 506), some of the rotatable fan devices, such as 1102, 1106, 1200, 1204 can be controlled to rotate towards the X direction (direction 506), thereby driving aircraft 100 to fly towards a direction opposite to X direction (direction 506) laterally and stably. As such, the aircraft can fly forwards or backwards in a lateral manner without tilting or in a very slightly (smaller than 30 degrees between main body and direction of movement) tilted position. Generally, if the main body is at an angle to the direction of movement (known as angle of attack), the main body is facing the sky, as for the aircraft itself, during the forward speed slowly increasing from 0 to a greater speed such as cruise speed, flying with a greater angle of attack generates more lift, transits from vertical take-off to forward flight quicker, and also increasing power efficiency. As speed increases, the angle of attack is slowly reduced to a minimum of no less than 0 degrees, where practically is less than 20 degrees. When this angle of attack is less than 7 degrees, the passengers have a better comfort level, the aircraft overall will also have a better stably.

Similarly, if the aircraft wants to fly towards Y direction (direction 504), some of the rotatable fan devices, such as 1102, 1106, 1200, 1204 can be controlled to turn towards a direction opposite to the Y direction (direction 504), thereby driving aircraft 100 to fly towards Y direction (direction 504) laterally and steadily; and vice versa.

When the aircraft 100 is in motion and want to brake suddenly, two nearby rotatable fan devices can be controlled to rotate symmetrically in a clockwise direction and an anti-clockwise direction respectively, resulting in the aircraft 100 to stop sharply from a flying state. For example, when the aircraft vehicle 100 is moving towards X direction and wants to brake suddenly, two rotatable fan devices 1102, 1106 can be controlled to rotate symmetrically in a clockwise direction and an anti-clockwise direction respectively, two rotatable fan devices 1200, 1204 can also be controlled to rotate symmetrically in a clockwise direction and an anti-clockwise direction respectively, such that the aircraft 100 brakes more sharply during sudden braking. When the aircraft 100 wants to land from a hovering state, fan speed of rotatable fan devices can be reduced gradually, allowing the aircraft 100 to complete the landing in a safer and more comfortable way.

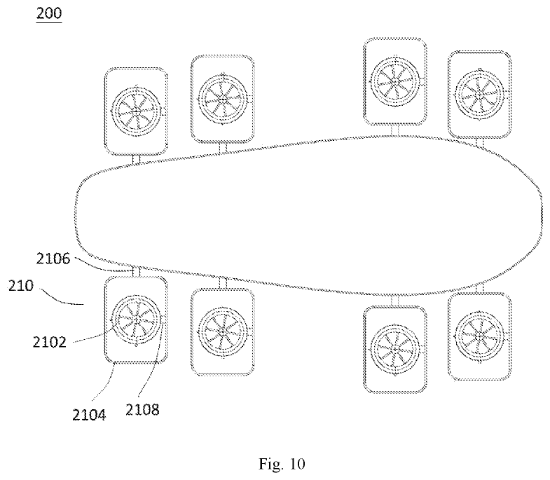

Referring to FIG. 10, another aircraft 200 according to the present invention is shown. The aircraft 200 also comprises multiple rotatable fan devices 210, which comprises a rotatable ducted fan 2102, a frame 2104, a frame rotation shaft 2106 and a rotatable fan rotation shaft 2108. Rotatable ducted fan 2102 has a similar structure to rotatable ducted fan 900, and is also provided with two angle adjustment levers for adjusting exit air flow direction. When the angle of rotation for the rotatable ducted fan 2102 is not big enough, the frame rotation shaft 2106 and the ducted fan rotation shaft 2108 can cooperate to increase the overall angle of rotation for the exit air flow of the rotatable fan device 210, such that the agility of aircraft device 200 is increased. Wherein, the two angle adjustment levers of the rotatable ducted fan 2102 have a different rotational speed to the frame rotation shaft 2106 and the ducted fan rotation shaft 2108. In general, the movement speed of the angle adjustment lever is faster than the rotation speed of the frame rotation shaft 2106 and the ducted fan rotation shaft 2108. Therefore, when the exit air flow direction needs a smaller and quicker change, it can be achieved by the two angle adjustment levers of the rotatable ducted fan 2102, while if the exit air flow direction needs a bigger change, the two angle adjustment levers needs to be moved along with rotation of the frame rotation shaft 2106 and the ducted fan rotation shaft 2108.

While the technical content of the present invention is disclosed as above, it is not meant to limit the present invention, any modifications or polishes made by a person skill in the art should be covered by the scope of the present invention. The scope of protection of the present invention shall be defined by the accompanying claims.

1. An aircraft, comprising:
a main body for carrying at least one object or passenger; and
multiple rotatable fan devices, disposed at two sides of said main body;
wherein an angle of rotation of one of said multiple rotatable fan devices can be changed, such that said aircraft flies along a direction at an angle, said angle being between 0 degrees and 30 degrees.

2. The aircraft according to claim 1, wherein said multiple rotatable fan devices comprises at least four groups symmetrically disposed at two sides of said main body.

3. The aircraft according to claim 1, wherein an angle of rotation of said multiple rotatable fan devices can be changed, such that said carrier aircraft can perform lateral flight.

4. The aircraft according to claim 1, further comprising:
two front wings symmetrically disposed at two sides of a front part of said main body, wherein a front fan group of said multiple rotatable fan devices is disposed on said two front wings respectively;
two rear flight wings symmetrically disposed at two sides of a rear part of said main body, wherein a rear fan group of said multiple rotatable fan devices is disposed on said two rear wings respectively; and
a tail wing disposed at a tail part of said main body.

5. The aircraft according to claim 4, wherein said front fan group comprises four rotatable fan groups with two disposed on each of two said two front wings, and said rear fan group comprises four rotatable fan groups with two disposed on each of said two rear wings.

6. The aircraft according to claim 5, wherein a first average distance between said front fan group and said main body is smaller than a second average distance between said rear fan group and said main body.

7. The aircraft according to claim 5, wherein a third average distance between said front fan group and a bottom surface of said main body is smaller than a fourth average distance between said rear fan group and said bottom surface of said main body.

8. The aircraft according to claim 4, wherein said tail wings comprises two tail fins disposed at two sides of said tail part of said main body respectively.

9. The aircraft according to claim 1, wherein one of said multiple rotatable fan devices comprises a rotatable ducted fan.

10. The aircraft according to claim 9, wherein one of said multiple rotatable fan devices further comprises a frame, wherein said rotatable ducted fan is disposed at a central region of said frame.

11. The aircraft according to claim 9, wherein said rotatable ducted fan comprises:
a ducted fan;
a first angle adjustment device for controlling said ducted fan to change an angle along a first plane;
a second angle adjustment device for controlling said ducted fan to change an angle along a second plane;
wherein said first plane is orthogonal to said second plane.

12. The aircraft according to claim 11, wherein said rotatable ducted fan further comprises:
a ducted fan fixed housing for accommodating and fixing said ducted fan; and
a ducted fan movable housing for accommodating said ducted fan;
wherein said first angle adjustment device and said second angle adjustment devices are coupled to said ducted fan fixed housing and said ducted fan movable housing.

13. The aircraft according to claim 11, wherein at least one of said first angle adjustment device and said second angle adjustment device is a lever structure for adjusting an angle of rotation of said ducted fan movable housing.

14. A method of driving an aircraft, said aircraft comprising a main body for carrying at least one object or passenger, and multiple rotatable fan devices disposed on said main body, said method comprising:
driving a first part of said multiple rotatable fan devices, causing said first part to exhaust to a ground direction;
driving a second part of said multiple rotatable fan devices, causing said second part to exhaust to a first direction; and
driving carrier aircraft to perform lateral flight towards a second direction.

15. The method according to claim 14, wherein said an angle between said first direction and said second direction is greater than 150 degrees.

16. The method according to claim 14, further comprising:
controlling two rotatable fans of said second part disposed at corresponding positions on two sides of said main body to rotate in a clockwise direction and an anti-clockwise direction respectively, causing said aircraft to stop suddenly from a flying state.
